(19) United States
(12) Patent Application Publication
(10) Pub. No.: US 2005/0163520 A1
(43) Pub. Date: Jul. 28, 2005

(54) Method and system for providing process control in reproduction devices

(75) Inventors: Kenneth P. Friedrich, Honeoye, NY (US); Matthias H. Regelsberger, Rochester, NY (US); Edward M. Eck, Lima, NY (US); Eric C. Stelter, Pittsford, NY (US); Joseph E. Guth, Holley, NY (US)

Correspondence Address: PATENT LEGAL STAFF;EASTMAN KODAK COMPANY, 343 STATE STREET, ROCHESTER, NY, 14650-2201, US

(73) Assignee: Eastman Kodak Company

(21) Appl. No.: 11/034,587

(22) Filed: Jan. 13, 2005

Related U.S. Application Data
(60) Provisional application No. 60/538,830, filed on Jan. 23, 2004.

(51) Int. Cl. G03G 15/09

(52) U.S. Cl. 399/53; 399/267

(57) ABSTRACT

An image production apparatus comprising a development unit for applying toner to an electrostatic image, the development unit having magnetic core rotating at a magnetic core rotation speed and a controller to control the magnetic core rotation speed in response to a parameter of the image production apparatus.

### RELATED APPLICATIONS

This application claims the benefit of the Provisional Application Ser. No. 60/538,830 entitled “METHOD AND SYSTEM FOR PROVIDING PROCESS CONTROL IN REPRODUCTION DEVICES”, filed on Jan. 23, 2004.

### FIELD OF THE INVENTION

This present invention relates to a system and method for providing electrostatic development of toner images in reproduction devices. More specifically, it relates to a system and method for controlling the application of toner using a magnetic brush toning device.

### BACKGROUND OF THE INVENTION

In the electrostatic development of xerographic images to a recording medium such as a photoconductor, the image is generally formed by electrical attraction to the recording medium from another medium or device bearing the toner. In other cases toner or powder can be applied directly to the recording medium without the use of a transfer device.

Often, such an electrostatographic recording device might have a magnetic brush toning station for applying toner to an electrostatic image. The magnetic brush, positioned within the toning station, usually includes a rotatable magnetic core situated within a conductive bias, non-magnetic sleeve. For example, in U.S. Pat. No. 4,546,060, by E. T. Miskinis and T. A. Jadwin, a method of toning an electrostatic image using a rapidly rotating magnetic core is provided. The rotating core is located inside a non-magnetic sleeve and causes a developer, which includes hard magnetic carrier particles and toner or powder, to move around the sleeve and through toning relation with the electrostatic image. Movement of the developer is caused by a rotating, rolling or tumbling action of the hard magnetic carrier particles when they are subjected to rapidly changing magnetic fields from the magnetic core. This tumbling action causes the developer to move in a direction around the sleeve often opposite that of the rotating core.

The non-magnetic sleeve itself could also be rotated to assist the developing process. Although it is known to rotate the sleeve in either direction, it commonly has been rotated in a direction parallel to the photoconductor and opposite to that of the core to assist in moving the developer usually in the same direction as the recording medium. This technology can provide a soft development brush and extremely high quality development.

In U.S. Pat. No. 5,196,887 to T. K. Hilbert is another type of a magnetic brush toning station in which developer is transported by a fluted roller from a sump area to an applicator. The developer is attracted to the fluted roller by a magnetic core inside the roller. The toning station includes a skive or a wiper positioned downstream from the development position for wiping developer off the non-magnetic sleeve to permit it to fall back into the sump for remixing.

While the above methods work well for toning an electrostatic image, it is important to note, that the magnetic brush should maintain a relatively consistent speed. If the magnetic brush undesirably varies in speed or direction, or both, image distortion and artifacts can occur, thus decreasing image quality. Often, a magnetic brush is driven by a motor via a clutch. Sometimes, the clutch can inadvertently slip, causing the magnetic brush speed to vary undesirably and consequently decrease image quality.

Moreover, as described above, it is not unusual for the magnetic core and the non-magnetic sleeve to rotate in opposite directions. It is also becoming more common that a separate motor be dedicated to drive the sleeve and another motor drive the magnetic core. In this situation, a malfunction of the drive motor rotating the magnetic brush could be catastrophic, resulting in an unintended developer dump from the still functioning rotating sleeve, possibly contaminating the machine.

A toning station with an independent motor driven magnetic core and sleeve can have its speed varied with respect to the recording medium speed. This allows the customer to selectively vary the speed of the an electrophotographic recording device depending on job requirements.

The embodiments described herein allow for more effectively controlling of image characteristics.

### SUMMARY OF THE INVENTION

Addressing the problems with magnetic toning stations typically found in an electrostatographic recording device as described above, the present embodiments provide the ability to more effectively control the image quality and can also provide error detection. The present embodiments are illustrated as exemplary embodiments that disclose a system and method capable of error detection, possibly reducing unintended developer dump, and reducing image artifacts in such reproduction machines.

In accordance with an aspect of the present invention, a magnetic brush including a monitored and rotatable magnetic core and a non-magnetic sleeve applies toner to an electrostatic image. In an exemplary embodiment, the rotational speed of the magnetic core is monitored by a sensor to provide feedback to control the speed of the rotating magnetic core. An error signal can be generated if the rotational speed of the magnetic core falls outside a range of values.

In accordance with another aspect of the present invention, a controller for maintaining a speed of a magnetic core is provided. In the exemplary embodiment, a controller is in communication with a sensor that can determine the speed and direction of the magnetic core. If the controller detects an increase or decrease in speed, it can initiate adjustment accordingly to maintain a desired speed at the magnetic core.

In accordance with yet another aspect of the present invention, a magnetic core is rotated and the image quality of a latent image is monitored. The rotational speed of the magnetic core is adjusted according to the monitored image quality.

The present invention provides a number of advantages and applications as will be more apparent to those skilled in the art. Utilizing the disclosed embodiments, the present invention allows for the reduction to unintended developer dumps and for increasing image quality by the reduction of image defects. Moreover, the disclosed embodiments can detect changes in the speed or direction of a magnetic core, and may correspondingly generate an error signal message, control and set the speed of the toning station drive, and control and regulate the speed of the toning station drive to a variable speed set-point.

The foregoing and other objects, features and advantages of the present embodiments will be apparent from the following more particular description of exemplary embodiments of the system and the method as illustrated in the accompanying drawings.

### BRIEF DESCRIPTION OF THE DRAWINGS

FIG. 1 is a side elevational view of an electrostatographic recording apparatus of the exemplary embodiment;

FIG. 2 is a side view of a portion of the electrostatographic recording apparatus shown in FIG. 1 with a portion of a single development and toning unit shown;

FIG. 3 is a side view of a portion of the development and toning unit of FIG. 2;

FIG. 4 is a block diagram illustrating a system for sensing a magnetic core of a toning station and generating a pass/fail error;

FIG. 5 is a diagram illustrating an exemplary use of a sensor in accordance with the exemplary embodiments;

FIG. 6 is a diagram illustrating another exemplary use of a sensor in accordance with the exemplary embodiments;

FIG. 7 is a block diagram illustrating a system for maintaining the speed and direction of the magnetic core of a toning station;

FIG. 8 is a block diagram illustrating a system for maintaining a variable speed and direction of the magnetic core of a toning station;

FIG. 9 is a graph illustrating the voltage in relation to the charge to mass ratio;

FIG. 10 is a graph illustrating the RPM of a magnetic core in relation to the voltage as found in FIG. 9; and

FIG. 11 is a plot illustrating the relationship between the rotational speed of the magnetic core and solid area density of an image.

### DETAILED DESCRIPTION OF PREFERRED EMBODIMENTS

The present embodiments described herein, provide the ability to more effectively control the image quality in an electrophotographic copier or printer. The present embodiments are described below in the environment of a particular electrophotographic copier and/or printer. However, it should be understood that although this invention is suitable for use with such described machines, it also can be used with other types of electrophotographic copiers and/or printers. Therefore, details regarding the electrophotographic copier and/or printer are provided as an example, and are not necessarily essential to the invention.

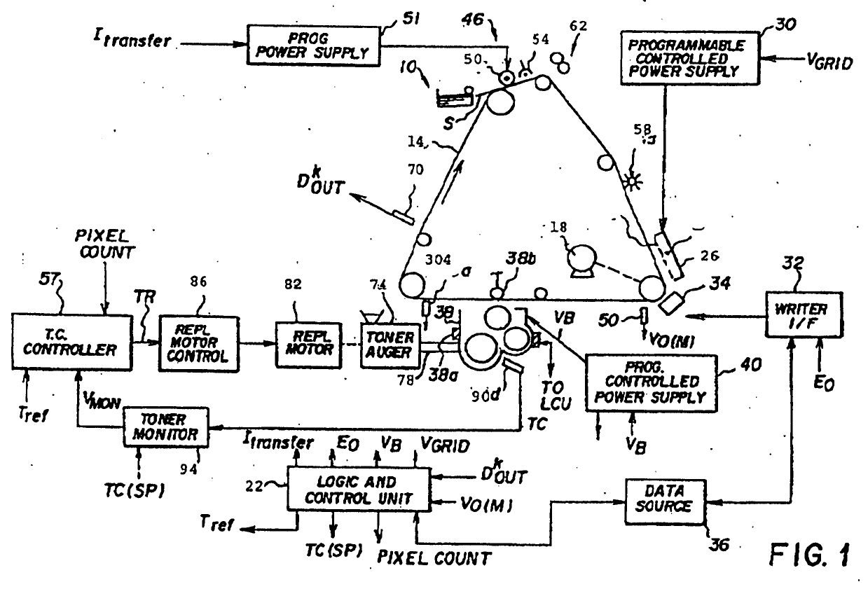

FIG. 1 is a schematic illustrating a side elevational view of an electrostatographic recording device of the exemplary embodiment. With reference to the device 10, a moving image recording member such as a photoconductive belt 14 is driven by a motor 18 past a series of work stations arranged along the path of the belt 14. The image recording member may also be in the form of a drum rather than the belt 14 of this particular embodiment. Preferably, a logic and control unit (“LCU”) 22, which may include a microprocessor or hardware logic, monitors the imaging process and appropriately enables the various work stations according to the desired process.

Preferably, the belt 14 passes a charging station 26 that sensitizes the belt 14 by applying a uniform electrostatic charge of primary voltage V_{O} to the belt's 14 surface. The output of the charging station 26 can be regulated by a programmable power supply 30, which communicates with the LCU 22 to adjust the primary voltage V_{O}. For example, as is well known in the art, the electrical film V₀ potential V_{GRID} can be applied to a grid that controls movement of charged ions, created by operation of the charging wires, to the surface of the image recording member, the surface of the belt 14 in this case.

At an exposure station 34, projected light from a write head can modulate the electrostatic charge on the belt 14 to form a latent electrostatic image of a document to be copied or printed. Preferably, the write head has an array of light-emitting diodes (“LEDs”) or other light sources, such as a laser or other exposure source, for exposing the belt 14 in a picture element by picture element (“pixel”) fashion with the intensity regulated in accordance with signals from the LCU 22 to a writer interface 32 that may also include a programmable controller. Alternatively, the exposure may be by optical projection of an image of a document or a patch onto the belt 14. Preferably, the same source that creates the patch used for process control described below can also expose the image information.

Where an LED or other electro-optical exposure source is used, image data for recording is provided by a data source 36 for generating electrical image signals such as a computer, a document scanner, a memory, a data network, etc. Signals from the data source 36, the LCU 22 or even both may also provide control signals to a writer network. Signals from the data source 36 or the LCU 22, or both may also provide control signals to the writer interface 32 for identifying exposure correction parameters (change in E₀ from the desired E₀, such as in a look-up table for use in controlling image density. In order to form patches with the desired density the LCU 22 may be provided with random access memory (“RAM”) or read only memory (“ROM”) or other memory representing data for the creation of a patch that may be input into the data source 36.

Travel of belt 14 brings the areas of the belt 14 bearing the latent electrostatographic charge images past a toning or development unit 38. The toning or development unit 38, described in more detail below, can have one or more (e.g., more stations if used for color reproduction) magnetic brushes in juxtaposition to, but spaced from, the travel path of the belt 14. Many different types of toning or development units can be utilized in accordance with the preferred embodiments, for example, both U.S. Pat. No. 4,473,029 to Fritz, et al. and U.S. Pat. No. 4,546,060 to Miskinis, et al. disclose just some of the available types of toning or development stations. The toning or development unit 38 may include one or more toning stations. To this end, various embodiments of a toning unit or station 38 will be described hereinafter and shown in the various drawings. Although perhaps numbered differently, these embodiments are representative of structures that perform the function of toning unit 38.

Preferably, the LCU 22 can selectively activate a toner station, within the toning or development unit 38, in relation to the passage of the image areas of the belt 14 containing latent images to selectively bring a magnetic brush of charged toner particles into engagement with or a small spacing apart from the belt 14. As is well understood in the art, conductive portions of the toner station, such as conductive application cylinders, act as electrodes. The electrodes are connected to a variable voltage supply V_{B} regulated by a programmable controller 40. The charged toner particles of the engaged magnetic brush are attracted to the latent image pattern to develop the pattern, which may include development of the patches used for process control. The toner station thus selectively deposits the charged toner particles according to the desired image under the control of the LCU 22.

A transfer station 46 is provided for handling and moving a receiver sheet (“S”) into engagement with the belt 14. The transfer station 46 moves the receiver sheet in register with the image for transferring the image to a receiver sheet such as plain paper. Alternatively, an intermediate member may have the image transferred to it and the image may then be transferred to the receiver sheet. The transfer station 46 may include a transfer roller 50 having one or more semiconductive layers that are preferably supported on a conductive core. An example of a transfer roller is disclosed in U.S. Pat. No. 6,074,756 to Vreeland et al. Alternatively, the core may be made insulative and electrical bias applied to the semiconductive layer(s). As an alternative to a transfer roller 50, a transfer belt or other handling mechanisms may be used. A semiconductive layer on the roller engages the receiver sheet in a nip formed between the transfer roller and the toner image bearing surface of the belt 14. Electrostatic transfer of the toner image can be effected with a proper voltage bias applied to the transfer roller 50 so as to generate a constant current or constant voltage depending on the type of transfer power supply.

After the transfer is complete the receiver sheet is preferably detacked from the belt 14, such as by using a detack corona charger 54, as is well known in the art. A cleaning station 58 is provided subsequent to the transfer station 46 for removing toner from the belt 14 to allow reuse of the surface for forming additional images. In lieu of the belt 14, a drum, photoconductor, or other structure for supporting an image may be used. After transfer of the unfixed toner images to a receiver sheet, such sheet is transported to a fuser station 62 where the image is fixed.

Preferably, the LCU 22 provides overall control of the machine and its various subsystems. Programming commercially available microprocessors or developing hardware circuits are conventional skills that are well understood in the art. In lieu of a microprocessor embodiment the logic operations described herein may be provided by or in combination with dedicated or programmable logic devices. In order to precisely control timing of various operating stations, it is well known to use encoders in conjunction with indicia on the photoconductor to timely provide positional indication through signals indicative of image frame areas and their position relative to various stations. Other types of control for timing of operations, as known in the art, may also be used.

Process control strategies generally utilize various sensors to provide real-time control of the electrostatographic process and to provide consistent image quality output from the user's perspective. One such sensor may be a densitometer 70 to monitor development of test patches preferably in non-image areas of the photoconductive belt 14. The densitometer 70 may include a light emitting diode (“LED”) of an appropriate wavelength that directs light through the belt 14 or is reflected by the belt 14 onto a photodiode or other. light detector.

In a two-component developer such as provided in the toning or development unit 38, toner can become depleted with use whereas magnetic carrier particles remain thereby affecting the toner concentration in a toner station positioned with the toning or development unit 38. Addition of toner to the toner station may be made from a toner replenisher device 74 that includes a source of toner and a toner auger 78 for transporting the toner to the toner station. A replenishment motor 82 can be provided for driving the auger 78. A replenishment motor control circuit 86 can control the speed of the auger 78 as well as the times the replenishment motor 82 is operating and thereby controls the feed rate and the times when toner replenishment is being provided. The motor control circuit 86 can operate at various adjustable duty cycles that are controlled by a toner replenishment signal (“TR”) that is input to the replenishment motor control circuit 86. Preferably, the signal TR is generated in response to a detection by a toner monitor of a toner concentration (“TC”) that is less than that of a set-point value. For example, a toner monitor sensor 90d is a transducer that can be located or mounted within or proximate the toner station and provides a signal TC related to toner concentration.

The TC signal is input to a toner monitor 94, which in a conventional toner monitor causes a voltage signal V_{MON} to be generated in accordance with a predetermined relationship between V_{MON} and TC. The voltage V_{MON} is then compared with a reference voltage, V_{REF}, of say 2.5 volts which might be expected for a desired toner concentration of say 10%. Differences of V_{MON} from this reference voltage can be used to adjust the rate of toner replenishment or the toner replenishment signal TR. In a more adjustable type of toner monitor such as one manufactured by Hitachi Metals, Ltd., the predetermined relationship between TC and V_{MON} offers a range of relationship choices. With such monitors, a particular parametric relationship between TC and V_{MON} may be selected in accordance with a voltage input representing a toner concentration set-point signal value, TC(SP). Thus, changes in TC(SP) can affect the rate of replenishment by affecting how the system responds to changes in toner concentration that is sensed by the toner monitor.

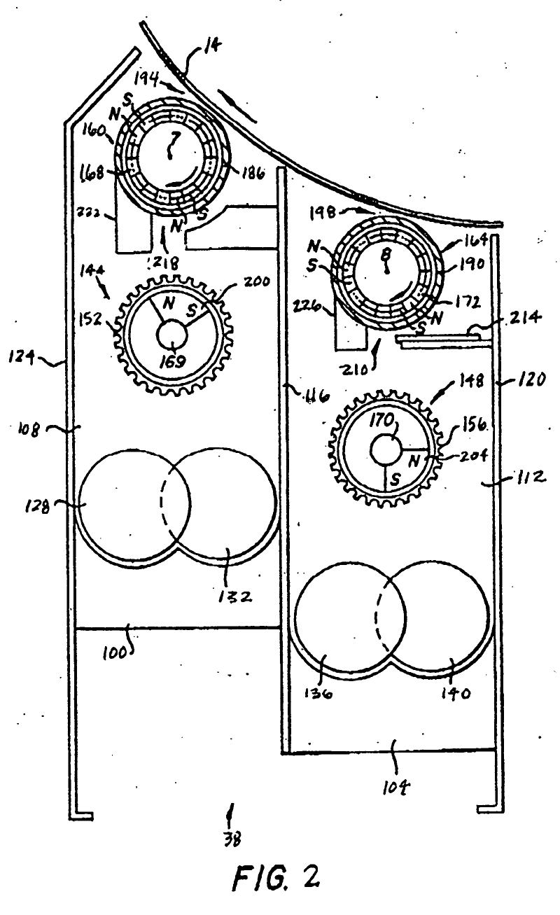

FIG. 2 illustrates a side view of an exemplary toning or development unit 38, such as utilized by the embodiment of FIG. 1. The toning or development unit 38 shown in this embodiment generally includes a first toning station 104 and a second toning station 100. Of course, it should be understood that the present embodiments are not limited to toning or development units 38 that use only two toning stations, but that they can be implemented on toning stations that utilize one or more toning stations.

Nevertheless, the toning or development station 38 is of a single unitary construction defining development chambers 108 and 112 for both toning stations 100, 104. Thus, in this example, stations 100 and 104 have a common center wall 116 and external side walls 120 and 124. Unitary end walls, not shown in this view, can further define both toning stations 100, 104.

Preferably, within each of development chambers 108 and 112 are mounted a pair of mixing devices, for example, paddle mixers 128, 132, 136, and 140, respectively, which can be constructed according to the teachings of U.S. Pat. No. 5,025,287 to Hilbert. Mixing devices 128, 132, 136, and 140 are in the sumps formed in the bottom of chambers 108 and 112. They are rotated rapidly to thoroughly mix a two-component developer and raise the level of the developer until it comes under the influence of developer transport devices 144 and 148 in each toning station 100 and 104. Developer transport devices 144 and 148 include rotatable transport rollers 152 and 156, respectively, each of which can have an outer fluted surface for transporting developer.

At the top of toning stations 100 and 104 are applicators 160 and 164, respectively. Each applicator 160 and 164 includes a rotatable magnetic core 168 and 172 and a non-magnetic sleeve 186 and 190. As seen in FIG. 2, magnetic cores 168 and 172 are rotatable in a clockwise direction that causes developer having a magnetic component to move in a counterclockwise direction around non-magnetic sleeves 186 and 190. This type of applicator can be used with single-component magnetic developer or conventional two-component developer having a magnetic carrier. However, it is preferably used with a two component developer having hard magnetic carrier and a non-magnetic toner such as that described in U.S. Pat. No. 4,546,060 to Miskinis, et al, U.S. Pat. No. 4,473,029 to Fritz, et al, and U.S. Pat. No. 4,531,832, to Kroll, et al. With such developer, rapid rotation of cores 168 and 172 cause the developer to move around sleeves 186 and 190 in a direction opposite to the direction of rotation of the cores 168 and 172, bringing the developer through development or toning positions 194 and 198 between sleeves 186 and 190 and the image surface of belt 14. Flow of developer around sleeves 186 and 190 can also be affected by rotation of sleeves 186 and 190 in either direction, as is well known in the art. In the exemplary embodiment of FIG. 2, the sleeves 186 and 190 are preferably rotated with the flow of developer.

Flow of developer from the bottom or sump portion of chambers 108 and 112 is maintained and controlled by several mechanisms. Developer above mixers 128 and 132, 136 and 140 is attracted to transport rollers 152 and 156 by magnetic gates 200 and 204. As shown in FIG. 2 with respect to toning station 104, developer above mixers 136 and 140 is attracted into contact with roller 156 by magnetic gate 204. Rotation of roller 156 brings the developer held by the gate 204 up to the top of transport device 148 where it is attracted by core 172 in applicator 164. With the magnetic gate 204 in the position shown with respect to toning station 104, station 104 is applying developer to an electrostatic image passing through toning position 198 on the image surface of belt 14.

As shown with respect to station 100, magnetic gate 200 has been rotated until it is facing applicator 160. Typically, in this position no developer is attracted to the transport roller 152 and developer is inhibited from leaving the top of transport device 144, thereby shutting off the supply of developer to applicator 160 to prevent toning by toning station 100 of an electrostatic image passing through development position 194. This structure, merely by the rotation of magnetic gate 200, controls whether or not station 100 applies toner to a passing electrostatic image. The stations do not need to be moved into and out of toning position between images.

Developer leaving transport roller 156 passes through an opening 210 associated with applicator 164 which assists in metering the amount of toner moved by applicator 164. As shown with respect to toning station 104, opening 210 can be given a factory or field adjustment in size by moving a sliding plate 214. With respect to toning station 100, the comparable opening 218 is shown permanently formed. Obviously, in commercial use both stations could have the same structure. They are shown different in FIG. 2 only to illustrate some of the possible variations.

Developer leaving developing positions 194 and 198 is separated from sleeves 186 and 190 by skives 222 and 226. As seen with respect to toning station 100, skive 222 and opening 218 can be defined by substantially the same element positioned and attached to center wall 116 between the stations 100, 104.

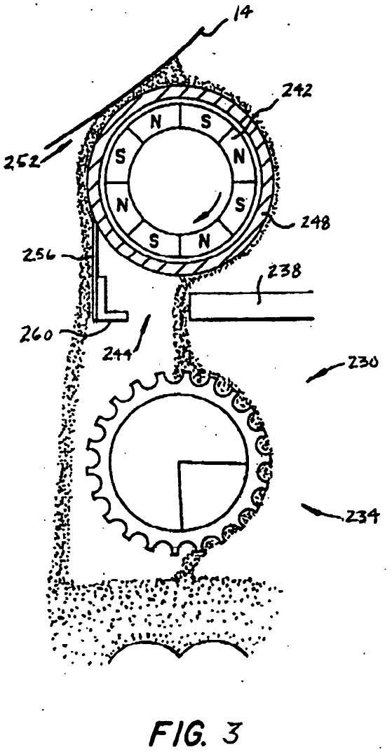

FIG. 3 illustrates general operation and aspects interior to each of the toning stations 100 and 104, however, the reference numbers referring to similar elements found in each of toning stations 100 and 104 are not necessarily used to illustrate the toning station 230. Developer in toning station 230 is transported by a transport roller 234 controlled by a gate 238 into the magnetic field of a rotating magnetic core 242 in the same manner as described with respect to toning stations 100 and 104 and shown in FIG. 2. Preferably, developer is attracted by core 242 through an opening 244 and into contact with a non-magnetic sleeve 248. Preferably, the sleeve is rotatable in a counterclockwise direction which supplements the effect of the clockwise rotation of core 242 on the hard carrier particles in the developer.

In the FIG. 3 embodiment, the developer is moved primarily by the rotation of core 242 from an upstream position adjacent or opposite opening 244 through a toning position 252. As described in U.S. Pat. No. 4,546,060 to Miskinis, et al., the rapid rotation of the core causes a rapid tumbling of the carrier because of the carrier's high coercivity. The outside surface of the non-magnetic sleeve 248 can be somewhat roughened. The tumbling of the carrier aided by the roughened surface causes the developer to move relative to the roughened surface. The tumbling of the carrier also greatly enhances the development of the image in the toning position 252, as explained in the Miskinis, et al. patent.

After the developer leaves the toning position 252 between the non-magnetic sleeve 248 and belt 14, it is starved of toner and is recirculated to the body of developer below transport 234 for remixing as described with respect to FIG. 3. To remove developer from the non-magnetic sleeve 248 it is skived by a blade shaped skive or wiper 256, spring urged against the non-magnetic sleeve 248 at a position downstream from toning position 252. Skive 256 is held by a support 260 which in this embodiment can also define opening 244.

This particular structure is designed for high quality color imaging, for example, imaging with high resolution typically using small spherical color toners in the 3 to 5 micron size range. In using this structure with small spherical hard magnetic carrier particles (for example, carrier particles in a size range between 20 and 40 microns), a problem with the traditional skive 256 may develop. Spent, toner-starved developer may be accumulated around the point of contact between the skive 256 and the non-magnetic sleeve 248. Because of the orientation of toning station 230 (compared to the other stations), skive 256 is very close to image belt 14. As starved developer backs up from skive 256 it may interfere with the image leaving the toning position. Carrier in this area has a tendency to be carried away by belt 14 creating well known problems further downstream.

Moreover, starved carrier buildup can reduce the density of the image, often causing dark background spots in white image areas by depositing unwanted toners or white spots in dark image area by unintentionally removing toner from the image. Of most importance, the buildup has a tendency to remain after the station has been turned off. That buildup then may inadvertently apply toner of the wrong color to an image to be toned by a downstream station creating a legacy of stained images.

To increase developer flow along the blade or skive 256, a size 400 grit can be applied to the appropriate or left-hand surface in this embodiment of the skive 256. This roughens the surface which causes the carrier particles which are still tumbling under the influence of core 242 to tumble down the skive 256 and away from belt 14. Although the roughened skive 256 is shown with respect to a counterclockwise moving sleeve 248, it is also usable with a clockwise moving sleeve and a stationary sleeve as well. The latter embodiment utilizes a moving sleeve.

Referring back to FIG. 1, as described above, the belt 14 can be rotated past a series of stations including a charging station 26, which preferably applies a uniform charge to the image surface. The charged image surface is then exposed by an exposure station 34, for example, a laser exposure station to create a series of electrostatic images. Those images are then toned by a one or more toning stations included in the toning or development unit 38.

As described above with reference to FIG. 3, a rotating magnetic core 242 located inside a non-magnetic sleeve 248 can cause a developer, which may include hard magnetic carrier particles, to move around the non-magnetic sleeve 248 and through toning relation with the electrostatic image. As known in the art, the magnetic core 242 and the non-magnetic sleeve 248 can be geared together, such that the magnetic core 242 and non-magnetic sleeve 248 may operate at the same time or they may utilize independent drives, where each drive might include a motor and drive clutch, separately for the magnetic core 242 and non-magnetic sleeve 248. In either case, when the magnetic core 242 is rotating, the sleeve 248 should also be rotating. Furthermore, it may be desirable to monitor the speed and direction of the magnetic core 242 and non-magnetic sleeve 248, such that undesirable image artifacts are prevented.

Image artifacts can occur if the magnetic core 242 undesirably varies in speed or direction. It has been found that a common cause of speed variation is slippage or malfunction of a drive clutch. If the drive clutch should slip, the magnetic core 242 speed is often directly affected, thus decreasing image quality. Additionally, if the motor for the non-magnetic sleeve 248 stops rotating, but the drive for the magnetic core 242 does not, this situation could result in an unintended developer dump perhaps contaminating the machine.

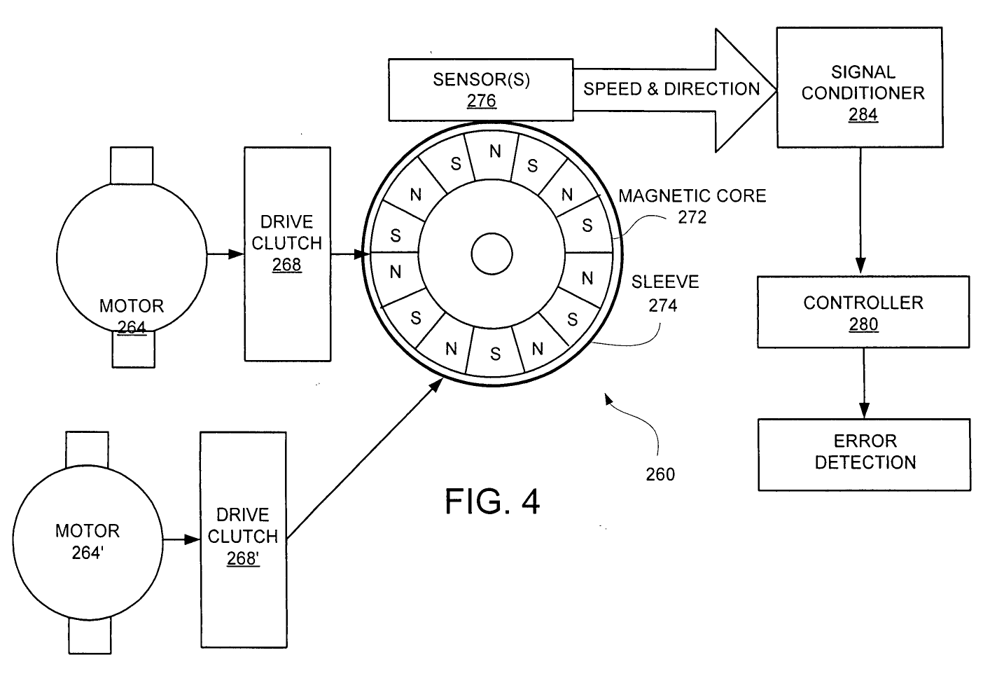

FIG. 4 is a block diagram illustrating an exemplary system 260 for facilitating image quality control in a reproduction apparatus, having a magnetic core 272. The system 260 generally includes a motor 264 and drive clutch 268 for rotating a magnetic core 272 at a speed. A sensor 276, and a controller 280 control the system. A rotating shell or sleeve 274 is driven by a motor 264′ and drive clutch 268′ at a speed and controlled by controller 280. Also included in the system 260 is a signal conditioner 284.

The exemplary embodiment shown in FIG. 4 includes a magnetic core 272 that has fourteen poles that are alternating in polarity of both north (“N”) and south (“S”). The magnetic core 272 can include a columnar roller having axially extending magnetic poles. Other types of magnetic cores, known in the art, with more or less poles may also be utilized.

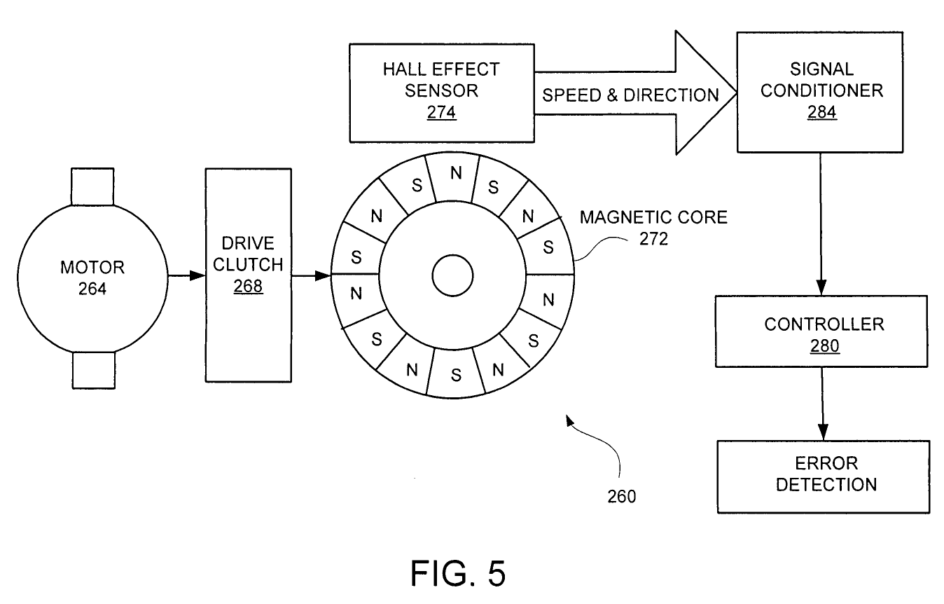

As shown in FIG. 5, the system 260 of FIG. 4 preferably includes a precision hall-effect latch chopper stabilized sensor 274. The hall-effect sensor 274 can preferably generate two signals that are used to determine both speed and direction, if so desired. The two signals can represent two waveforms out of phase of one another that are used to determine the speed and direction of the magnetic core 272. In the exemplary embodiment, the frequency of one waveform represents the speed of the magnetic core 272, such that the speed of the magnetic core 272 and the frequency of the waveform are proportional.

For example, according to the above described embodiment, if the speed of the magnetic core 272 increases, the frequency of the waveform will also increase. If the direction of the magnetic core 272 changes, then the two waveforms will consequently shift in phase to indicate a change in direction. Other types of hall-effect sensors may be utilized such as the A3425LK dual, chopper-stabilized, ultra-sensitive, BipolarHall-effect switch manufactured by Allegro Microsystems, Inc. located in Worcester, Mass.

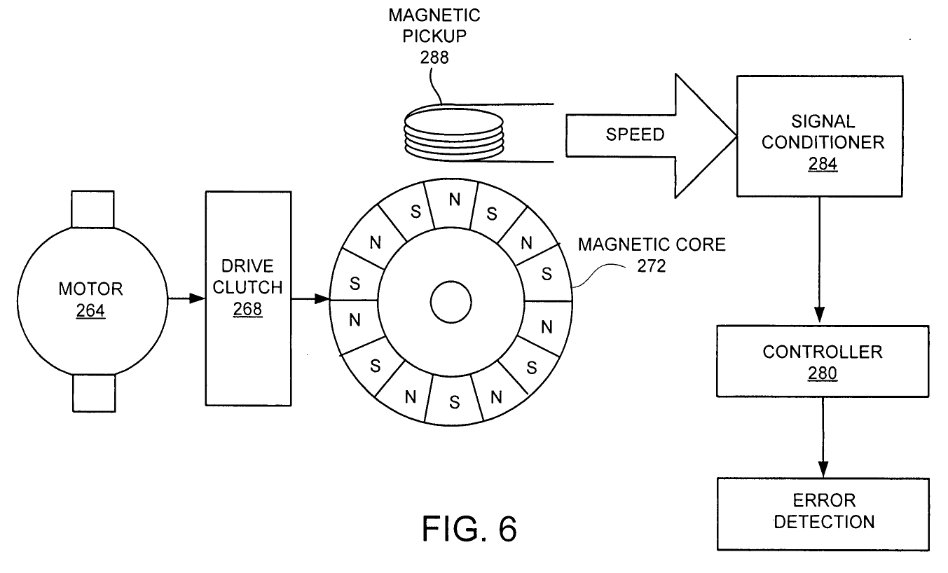

In another embodiment, the speed of the magnetic core 272 can be measured by a magnetic pickup or encoder. The magnetic pickup 288 and senor 276, as shown in FIG. 6, can directly measure pole flips per second (e.g., a pole flip can refer to detecting a polarity change, such as detecting North and South, or equivalently South and North) without any moving parts, which can give the magnetic pickup a higher inherent reliability and lower cost than commercially available encoders.

By measuring the magnetic pole flips per second, the speed of the magnetic core 272 can be determined. For example, according to described embodiment, when a pole change occurs, the variation of the magnetic flux caused by the magnetic core 272 can result from the time variation of the magnetic flux enclosed by the magnetic pickup 288. This variation in magnetic flux with time can cause a current in the magnetic pickup 288, indicating that voltage is induced across the magnetic pickup 288. The voltage changes across the magnetic pickup 288 can indicate pole flips and ultimately the magnetic core 272 speed such as in RPM.

In yet another embodiment, other sensors may also be utilized in accordance with the exemplary embodiments, such as optical encoders or shaft encoders to determine the magnetic core 272 speed. Additionally, it may be desirable to monitor the rotational speed of the non-magnetic sleeve to compare the speed of the sleeve to the speed of the magnetic core 272 speed for process control reasons. For example, it may be desirable to form a ratio of rotational speeds including the speed of the magnetic core 272 and of the sleeve. This ratio can then be used in process control by maintaining an appropriate ratio to provide for better image quality control.

Referring back to FIG. 5, the information from the sensor 276, such as in the form of a square wave, can be transmitted to a signal conditioner 284 to square up the pulses, filter unwanted noise appropriate for use in either analog signal processing such a frequency to voltage converters or digital signal processing such as frequency counters. From the signal conditioner 284, the signal can pass to the controller 280 where the speed of the magnetic core 272 is determined. Thus, if the magnetic core 272 or sleeve 274 has stopped or changed speed individually or relative to one another, an error can be generated such as to inform an operator. Or, the controller 280 can compare the speed of the magnetic core 272 to the speed of the non-magnetic sleeve (not shown in FIG. 4) to determine if the speed of the magnetic core is set appropriately. If not, the controller 280 can generate an error signal to indicate that the sleeve and core 272 are not operating properly (i.e. in sync or at desired speed(s)). It would be appreciated by one skilled in the art, that the signal in response to the magnetic core 272 speed and direction could be utilized in many different ways, such as an error can be generated in response to detecting a large variation in the monitored speed, monitored direction, or both. In the exemplary embodiment, the error is generated when the speed is greater than +/−5% of the nominal RPM leading to stopping of the motor. A warning is provided at greater than +/−2.5% of nominal RPM with print production.

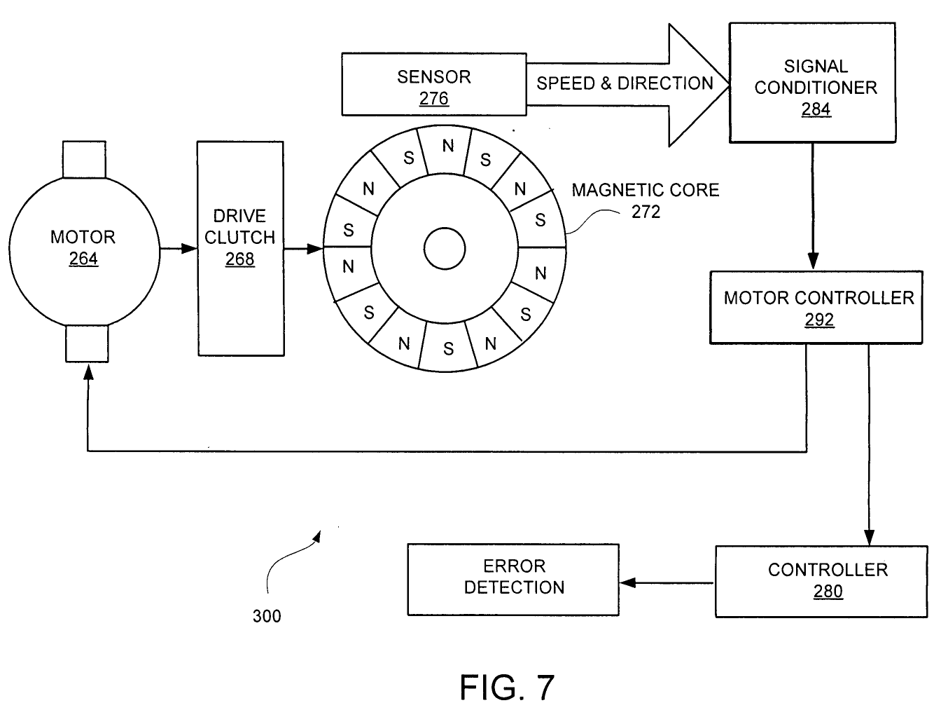

It may be desirable to set the speed of the magnetic core 272 to a constant speed. To do this, a set-point of voltage parameter could be set to directly change the voltage of the motor input. FIG. 7 illustrates an exemplary embodiment of a system 300 that utilizing the exemplary system 260 shown in FIG. 4 can maintain a constant set-point for the speed of the magnetic core 272. The system 300 generally includes a motor controller 292 for receiving the signal in response to the magnetic core 272 speed and direction, and upon receipt of the signal, the motor controller 292 compares the speed to the set-point. Consequently, if the speed of the magnetic core 272 is greater than the set-point, the motor speed can be adjusted accordingly until the speed of the magnetic core 272 is relatively equal to the set-point, (i.e., within a small range of speeds allowing for tolerances in the hardware/software components utilized). Also shown in FIG. 7 is a controller 280 for performing the same functions as the embodiment shown in FIG. 4.

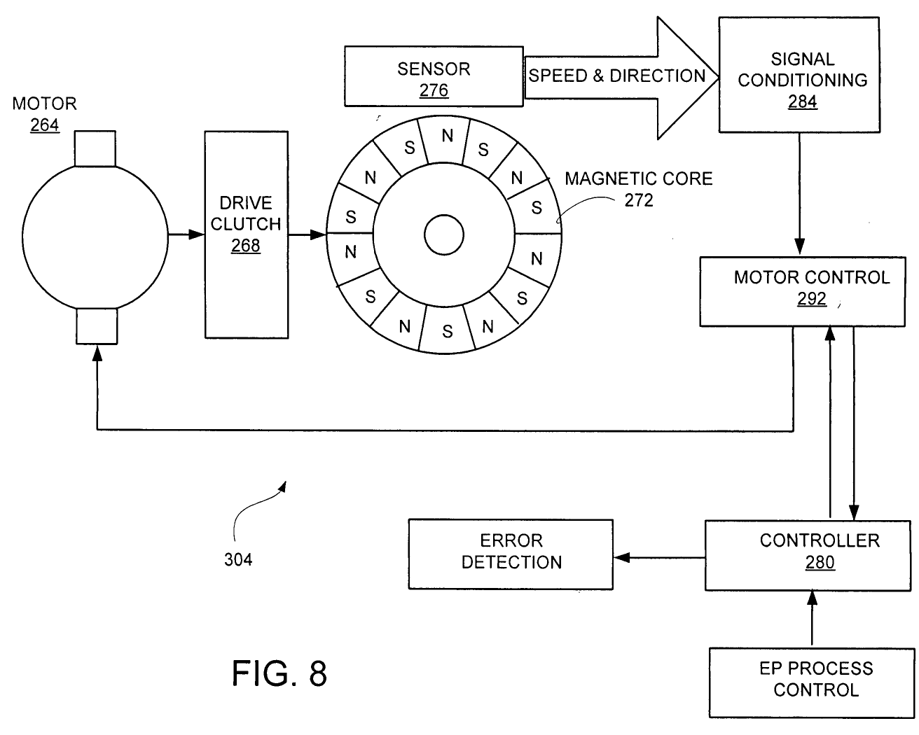

It may be also desirable to utilize the signal in response to the speed and direction of the magnetic core 272 to assist in adjusting the magnetic core 272 speed to variable set point delivered and set by the process control, preferably stabilizing the development of a latent image as illustrated by system 304 in FIG. 8. According to this embodiment, image characteristics, such as edge balance of toned area and line width, are preferably stabilized to nominal values for the entire range of toner charge-to-mass. In addition, by utilizing the system 304 toning efficiency can be increased by decreasing the V_{O} range necessary to accommodate a certain range in charge-to-mass, described more below. Conversely for the same dynamic V_{O} range, a larger range in toner charge-to-mass ratio can be allowed and still yield peak image quality, also described below.

In this embodiment, the setpoint for the toning station speed is derived for the V_{O}-setpoint analogous to the derivation of the transfer current setpoint described in example for a similar apparatus found in U.S. Pat. No. 5,937,229 to Walgrove, et al., the contents of which are incorporated by reference. The controller 280 can determine the speed setpoints utilizing the process control according to the above reference. Calculation of the speed setpoints of the magnetic core 272 in a toning station can be performed according to the relation: RPM=a(Voₛₑₜₚₒᵢₙₜ−Vo_{anchor})+RPM_{anchor} where a is a proportionality constant, Vo_{anchor} and RPM_{anchor} are default parameters, and Voₛₑₜₚₒᵢₙₜ is an adjustment parameter preferably utilized to optimize the system. The default parameters Vo_{anchor} and RPM_{anchor} can ensure that the average machine (e.g., a function of mechanical tolerances) with average materials (e.g., a function of materials manufacturing process) at average ambient conditions will produce marks on paper. The adjustment parameter Voₛₑₜₚₒᵢₙₜ can be utilized to optimize the image quality for a specific machine with specific materials, and in specific current ambient conditions.

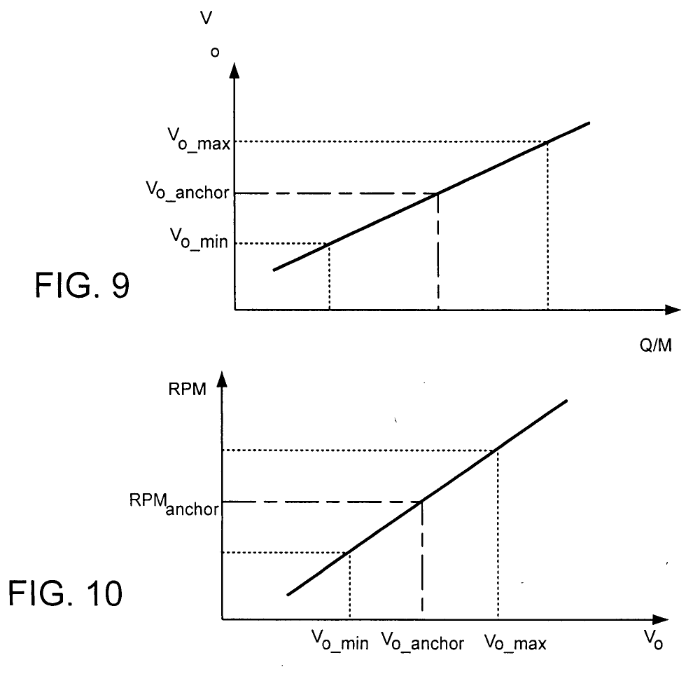

In this equation, the term (Voₛₑₜₚₒᵢₙₜ−Vo_{anchor}) expresses the deviation of Voₛₑₜₚₒᵢₙₜ from the anchor point for Vo. With that, the magnetic core 272 speed setpoint (RPM) is modified proportionally to the deviation from the Vo anchor point around the anchor point of the magnetic core 272 speed. With the Voₛₑₜₚₒᵢₙₜ being an indirect measure for the charge-to-mass ratio (“Q/m”) of the toner as illustrated in FIG. 8, and described below the equation above can vary the magnetic core 272 speed proportional to the charge-to-mass ratio of the toner as illustrated in FIG. 9.

To determine the proper RPM, the Q/m can be determined, more of which is described below. Referring to FIG. 9, assuming the process control, such as calculated by LCU 22 (FIG. 1), has determined Q/m, the corresponding Vo, within range given by Vo max and Vo min, can then be found using the direct relationship. For toner used in this example, the high Q/m ratio conditions more likely occurs at high humidity. The Vo utilized helps assure that the proper voltage is applied to belt 14 in accordance with the toner's determined characteristic parameter Q/m.

Referring to FIG. 10, using the determined Vo found using the relationship in FIG. 9, the magnetic core 272 speed can be determined. Once the desired speed is determined, adjustment to the potential at the motor 264 can also be provided for to obtain the desired speed.

With reference again to FIG. 1, as an alternative to using a relationship between a process control parameter determined by LCU 22 and transfer current to change transfer current as described in U.S. Pat. No. 5,937,229, the charge to mass ratio may be sensed directly. In this regard and as an illustrative but not preferred example, an additional electrometer 304 may be located after the toning and development unit 38 to measure the charge on a developed process control patch area. Q/m can be calculated directly by using the electrometer reading 50 of the primary charge voltage, V_{O}, less the voltage on the developed patch area and dividing this by the signal Dₒᵤₜ^{k}.

Alternatively, measurement of the toning bias current during the development of the process control patch can be a direct measure of the toner charge, Q. The current reading normalized by the patch size and divided by the mass laydown (determined from densitometer 70 readings) yields Q/m. This ratio will be related to Q/m because there is a known relationship for a specific toner between density and mass; thus, reference herein to a charge to mass ratio or parameter implies charge to density also. For each apparatus and toner, a relationship may be determined between charge to mass (or density) ratio and proper voltage V_{O} and conversion values stored in LCU 22.

During operation of the apparatus as patches are created for adjusting process setpoints, a calculation of Q/m or readings of the separate elements of this ratio may be input to the LCU 22 or controller 280 (FIGS. 4-8), or both, and used to generate an updated voltage in accordance with a predetermined relationship between Q/m and voltage. As one example, see the graph of FIG. 9. The voltage is changed accordingly as described above. Other methods for measuring charge to mass or charge and mass or some functional relationship involving charge and mass may be used in this regard, see for example, U.S. Pat. Nos. 5,235,388; 4,026,643 and 5,416,564.

As an additional alternative, read values of electrometer 50 and densitometer 70 may be input into LCU 22 and, as known in the art, used to determine an update of transfer current more directly rather than relying upon a relationship between a process parameter and the transfer current.

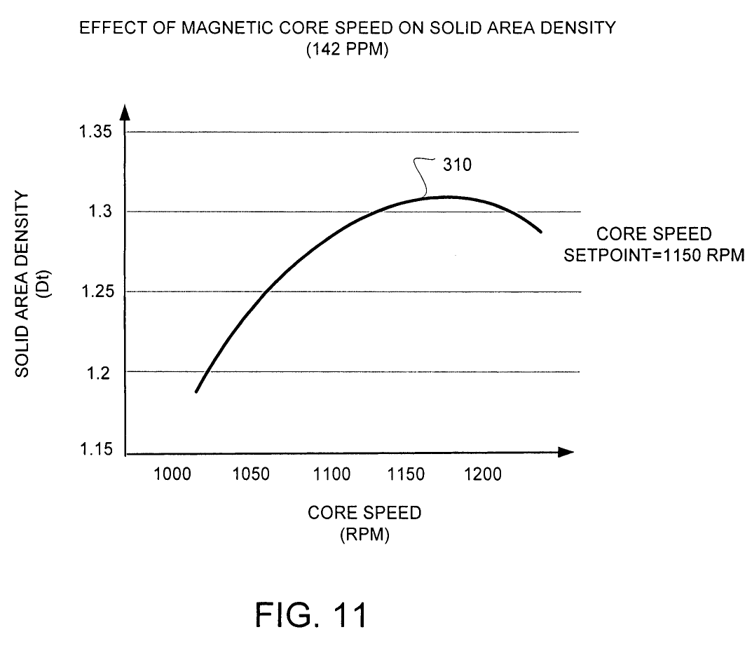

FIG. 11 is a graph illustrating data collected that shows by increasing the magnetic core speed, the solid area density increases to a maximum 310. At higher speeds above this maximum, the solid area density (or equivalently, the image density) as measured with a commercially available densitometer can decrease and then increase again (not shown). This graph can be used for process control, for example, image density can be measured by a densitometer 70 (FIG. 1), and typically, process parameters such as voltage V_{O} and image exposure are increased to increase density. However, utilizing the data found in FIG. 11, the magnetic core 272 speed can also be used to control density. In the described embodiment, separate drive motors are utilized for the magnetic core 272 and the sleeve 186 and 190 (FIG. 2). Furthermore, the magnetic core 272 speed can be set to a desirable speed and maintained utilizing the embodiments disclosed herein.

The present invention provides a number of advantages and applications as will be more apparent to those skilled in the art. Utilizing the disclosed embodiments, the present invention can allow for increased image quality by the reduction of image defects and by reducing unintended developer dumps. Moreover, the disclosed embodiments can detect change in the speed or direction, or both of a magnetic core and, if necessary, can correspondingly generate an error signal message, control and set the speed of the toning station drive, and control and regulate the speed of the toning station drive to a variable speed set-point.

It should be understood that the programs, processes, methods and systems described herein are not related or limited to any particular type of hardware, such as TTL logic or computer software, or both. Various types of general purpose or specialized processors, such as micro-controllers may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, more or fewer elements may be used in the block diagrams and signals may include analog, digital, or both. While various elements of the preferred embodiments have been described as being implemented in hardware, in other embodiments in software implementations may alternatively be used, and vice-versa.

The claims should not be read as limited to the described order or elements unless stated to that effect. Therefore, all embodiments that come within the scope and spirit of the following claims and equivalents thereto are claimed as the invention.

1. An image production apparatus comprising:
a development unit for applying toner to an electrostatic image, the development unit having
a magnetic core rotating at a magnetic core rotation speed; and
a controller to control the magnetic core rotation speed.

2. The apparatus of claim 1, further comprising a sleeve for rotating around the magnetic core at a sleeve rotation.

3. The apparatus of claim 2, wherein the sleeve and magnetic core rotate in different directions.

4. The apparatus of claim 1, wherein the controller is responsive to a sensor.

5. The apparatus of claim 1, wherein the sensor comprises either hall-effect device, a magnetic pickup, an optical encoder, or a shaft encoder.

6. The apparatus of claim 1, wherein the controller maintains the magnetic core speed to a set point.

7. The apparatus of claim 1, wherein the controller maintains the magnetic core speed relative to the sleeve speed.

8. The apparatus of claim 1, wherein the controller further monitors direction of the magnetic core.

9. A method for process control of an image reproduction device having a development unit with a magnetic core, the method comprising:
applying toner to an electrostatic image with a development unit, the development unit having a rotating magnetic core;
monitoring a parameter of the image reproduction device; and
adjusting the rotational speed of the magnetic core in response to the parameter.

10. The method of claim 9, wherein the parameter is monitored according to density of the toner.

11. A method in accordance with claim 9, wherein the image production apparatus further comprises a sleeve having a second rotational speed around the magnetic core, and further comprising the steps of monitoring the second rotational speed and controlling the image production apparatus in response to the first and second rotational speeds.

12. The method of claim 9, wherein the step of monitoring the magnetic core speed comprises using a hall-effect sensor.

13. The method of claim 9, further comprising the step of dynamically adjusting the speed of the magnetic core in accordance to the monitored speed to maintain a desired speed at the magnetic core.

14. The method of claim 9, further comprising the step of dynamically adjusting the speed of the magnetic core in response to charge-to-mass ratio of the toner.

15. The method of claim 13, wherein the dynamically adjusted speed of the magnetic core assists in stabilizing the development of a latent image.

16. The method of claim 9, wherein the adjusting step further comprises adjusting the direction of the magnetic core.

17. An apparatus for providing image quality control in an electrostatographic recording device comprising:
a rotating magnetic core for applying developer material to a latent image;
a sensor that senses the rotational speed of the magnetic core; and
a controller for controlling the rotational speed of the magnetic core in response to variations in the sensed rotational speed.

18. The apparatus of claim 17, wherein the magnetic core is located in a two-component toning station, wherein the magnetic core contributes to image characteristics in response to the rotational speed.

19. The apparatus of claim 17, wherein the controller dynamically adjusts the speed of the magnetic core in response to charge-to-mass ratio of the toner.

20. The apparatus of claim 17, further comprising a sleeve for rotating around the core and wherein the controller controls the ratio of the speed of the magnetic core relative to a speed of the sleeve.

21. The apparatus of claim 17, wherein the controller further controls the direction of the magnetic core.
